(19) United States
(12) Patent Application Publication
(10) Pub. No.: US 2006/0052988 A1
(43) Pub. Date: Mar. 9, 2006

(54) Compressed vector-based spectral analysis method and system for nonlinear rf blocks

(76) Inventors: Shahin Farahani, Chandler, AZ (US); Sayfe Kiaei, Scottsdale, AZ (US); Nazanin Darbanian, Chandler, AZ (US)

Correspondence Address: Daniel M Cavanagh;Christie Parker & Hale, Post Office Box 7068, Pasadena, CA, 91109-7068, US

(21) Appl. No.: 10/535,616

(22) PCT Filed: Nov. 21, 2003
(86) PCT No.: PCT/US03/37298

§ 371 Date: May 19, 2005

Related U.S. Application Data
(60) Provisional application No. 60/428,432, filed on Nov. 21, 2002.

(51) Int. Cl. G06F 17/10

(52) U.S. Cl. 703/2

(57) ABSTRACT

A method and system of simulating components using a compressed signal representation. In some embodiments compressed vector based equivalent signals and blocks are used to model signal processing systems, in particular RF wireless components.

### CROSS-REFERENCE TO RELATED APPLICATION

This application claims the benefit of the filing date of U.S. Provisional Application No. 60/428,432, filed Nov. 21, 2002, entitled “Compressed Vector-Based Spectral Analysis Method and System for NonLinear RF Blocks”, the disclosure of which is incorporated by reference herein.

### BACKGROUND OF THE INVENTION

The present invention relates generally to simulation of signal processing systems, and more particularly to simulation of RF signal processing systems.

Wireless communication circuits and systems are becoming increasingly common. Wireless communication circuits and systems are often tested by simulation before fabrication to ensure correctness of operation and to help categorize wireless device components. Simulation of wireless communication components allows designers to investigate new designs and to test design changes without expending time and money in producing physical samples.

Non-linear blocks are often present in wireless communication systems. For example, low noise amplifiers (LNAs) are often limited by voltage sources having upper and lower bounds which limit the dynamic range of the LNA. Mixers are often subject to leakage from local oscillators, with self-mixing potentially occurring with the RF signal. In addition, both active and passive devices of all blocks may introduce non-linearities at the device level.

Non-linearities may introduce additional spectral components in the form of undesired harmonics of input signals, intermodulation, and gain compression, for example. The undesired harmonics may negatively affect circuit operation. Intermodulation, particularly of undesired harmonics in a multi-tone system, may distort a signal being processed, as well increase system complexity by requiring DC offset cancellation circuitry or complex filters. Non-linearities also may result in reduced gain, through clipping or other effects.

Accordingly, preferably simulation of wireless communication systems and components includes simulation of non-linear blocks or elements. However, simulation of non-linear elements may be difficult. Simulation of non-linearities may be extremely expensive from a computational perspective, with for example extraneous signal components spread about the continous spectrum. This computational expense is further increased if the non-linear blocks include memory.

### SUMMARY OF THE INVENTION

The invention provides a simulation system and method for simulating RF systems including non-linear elements.

One aspect of the invention provides a method of simulating radio frequency signal processing circuitry, comprising forming a compressed vector based equivalent of a signal;

performing processing on the compressed vector based equivalent to simulate radio frequency circuitry operation, the processing forming a processed compressed vector based equivalent of the signal; and forming an output signal using the processed compressed vector based equivalent of the signal.

Another aspect of the invention provides a method of modelling circuitry, comprising converting first signals to compressed equivalent signals; processing the compressed equivalent signals to form further compressed equivalent signals; and converting the further compressed equivalent signals to second signals.

Another aspect of the invention provides a system for performing RF signal processing modelling, the system comprising signal generator blocks forming compressed vector based equivalent signal representations; RF signal processing blocks processing compressed vector based equivalent signal representations; and conversion blocks converting compressed vector based equivalent signals to RF signal representations.

These and other aspects of the invention are more fully understood in view of this disclosure.

### BRIEF DESCRIPTION OF THE FIGS.

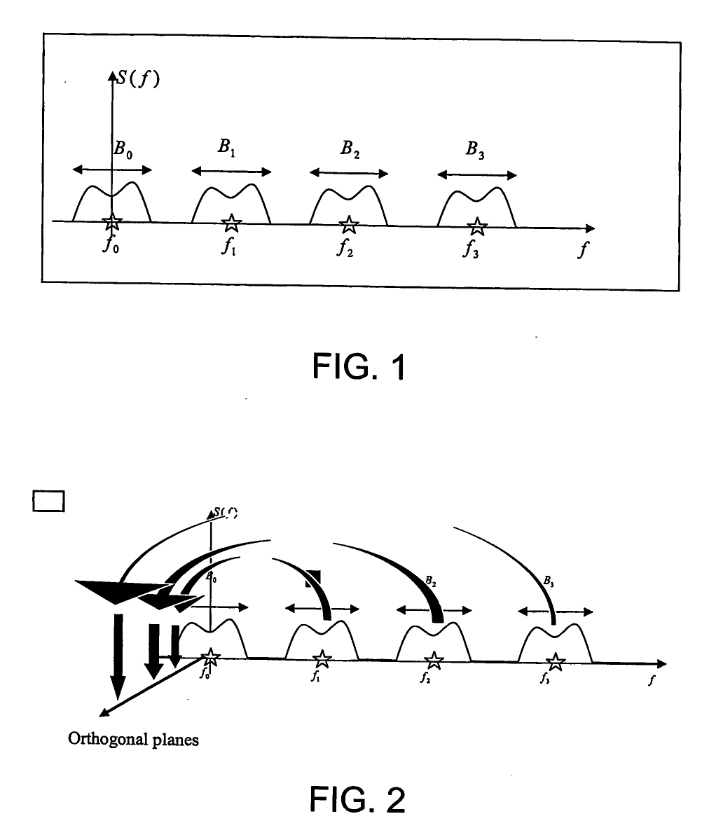

FIG. 1 illustrates an example RF signal;

FIG. 2 illustrates the example RF signal with bands of the example RF signal translated to an orthogonal plane;

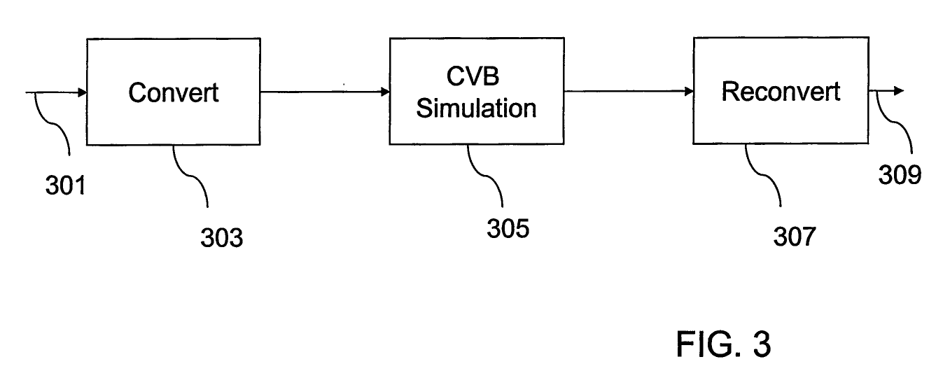

FIG. 3 is a block diagram of a system in accordance with aspects of the invention;

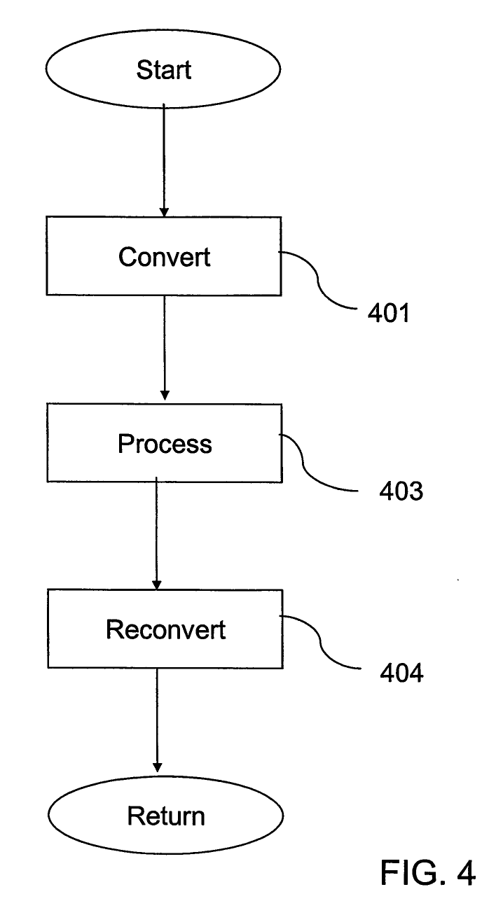

FIG. 4 is a flow diagram of a process in accordance with aspects of the invention;

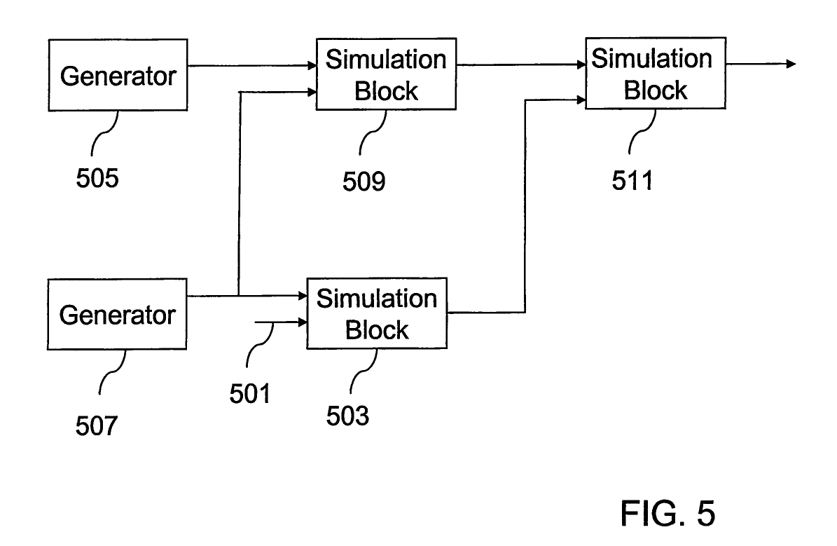

FIG. 5 is a further block diagram of a system in accordance with aspects of the invention;

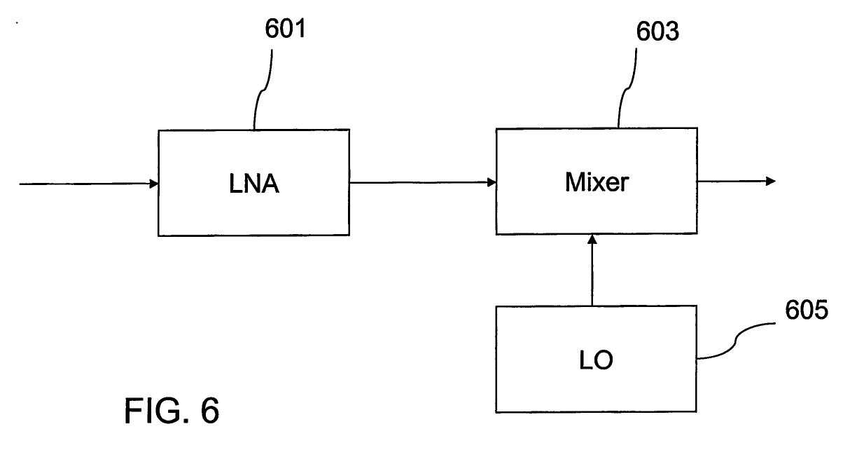

FIG. 6 is a block diagram of a system simulated in accordance with aspects of the invention;

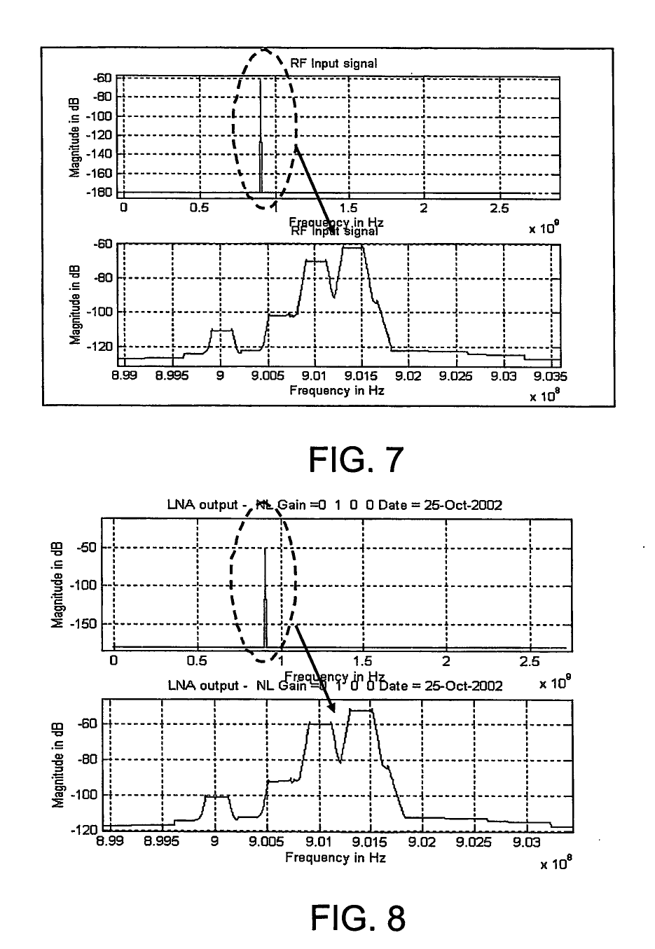

FIG. 7 is a graph of power spectral density (PSD) of an interference signal;

FIG. 8 is a graph of a simulated output of a linear LNA in the system of FIG. 6;

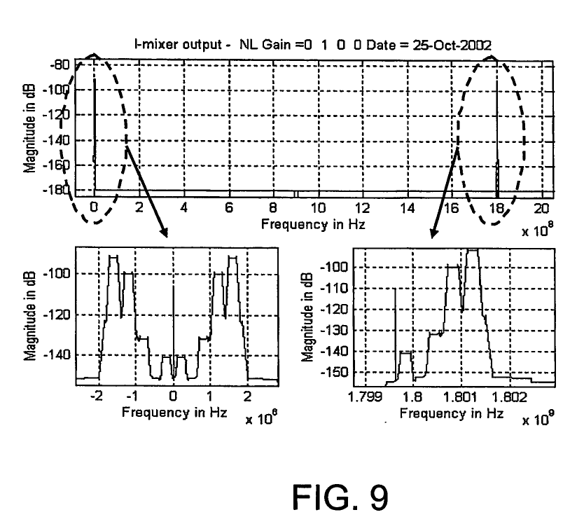

FIG. 9 is a graph of a simulated output of a linear mixer in the system of FIG. 6;

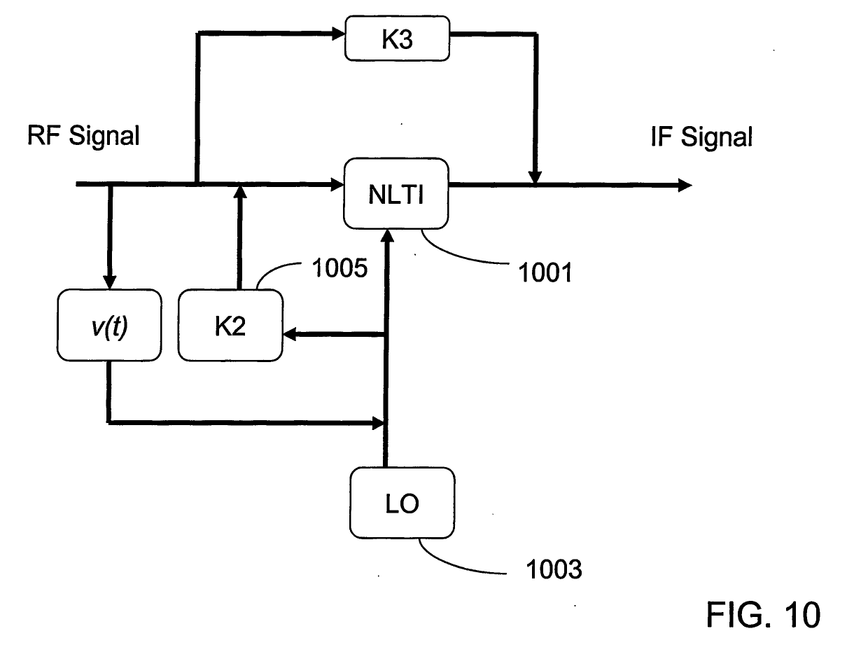

FIG. 10 is a block diagram of a mixer simulated in accordance with aspects of the invention;

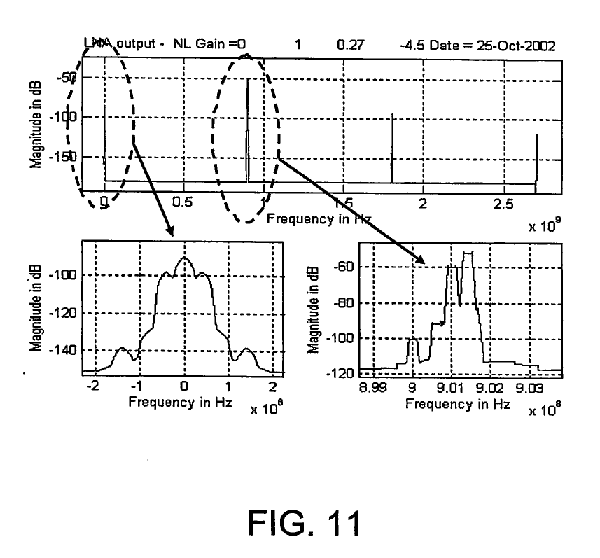

FIG. 11 is a graph of a simulated output of a non-linear LNA of the system of FIG. 6;

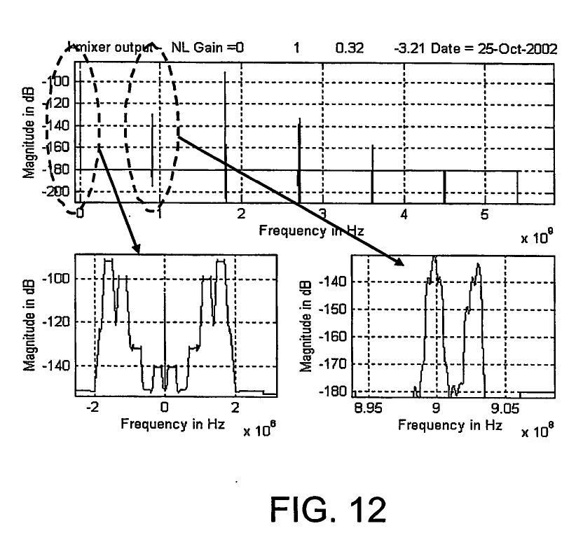

FIG. 12 is a graph of a simulated output of a non-linear mixer of the system of FIG. 6; and

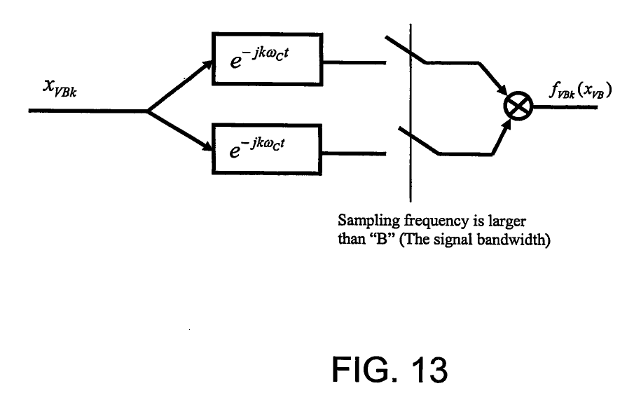

FIG. 13 is a block diagram of a CVB time domain implementation of a function.

### DETAILED DESCRIPTION

FIG. 1 illustrates an example RF signal. The example RF signal components centered about frequencies f₀, f₁, f₂ and f₃. The signal components are non-zero in frequency bands having bandwidths B₀, B₁, B₂, and B₃, each centered about f₀, f₁, f₂, and f₃, respectively. As illustrated, elsewhere in the frequency spectrum the RF signal is zero. In actuality, noise and various other factors may result in non-zero signal components outside of the frequency bands but these signal components are often of relatively low strength.

The RF signal may be viewed as similar to RF signals often encountered in wireless communication systems. For example, a wireless communication system may utilize a carrier frequency, represented in FIG. 1 as f₁. Harmonics of the signal at the carrier frequency are found at frequencies f₂ and f₃. A subharmonic, or a DC component, is located at frequency f₀. Often, only the signal components about the carrier frequency and a few of the harmonics are of sufficient strength to be of interest. Thus, for the RF signal of FIG. 1, the signal components centered about f₀, f₁, f₂, and f₃ may be considered frequency bands of interest.

Accordingly, aspects of the invention may be viewed as using only frequency bands of interest in simulation of a device, or of non-linear blocks of a device. In FIG. 2 the signal components in the frequency bands of interest of FIG. 1 are orthogonally transformed to lower frequencies. This is accomplished by defining orthogonal coordinates in an orthogonal plane. The signal components in the frequency bands of interest are translated to the orthogonal plane. If the signal components are viewed as vectors, the signal components in the orthogonal plane may be viewed as compressed vectors, as the vector information in the orthogonal plane is reduced compared to the vector information in the frequency plane.

As an example, consider a 900 GSM 900 MHz application. The application has a carrier frequency of 900 MHz. In the example, the application has a third order non-linearity, so that three harmonics are of interest. The total signal bandwidth is therefore 2.7 GHz. If a sampling frequency is 1 KHz, a vector of length 2,7000,000 defines the sampled signal. If, however, the channel bandwidth is 6 MHz a significant portion of the vector contains information not of particular importance.

Creation of vectors containing information for frequency bands of interest, for example in a matrix form, allows for significantly reduced, or compressed, vector size. As the three harmonics are of interest in the example, four vectors may be formed, each defined by samples formed using a 1 KHz sampling frequency in the frequency bands of interest. Each band provides a vector of length 6,000, and the four frequency bands of interest therefore provide a matrix with 24,000 entries, as opposed to 2,700,000 entries otherwise provided. A reduced number of computations may be performed in view of the reduced matrix size.

In aspects of the invention, summation, multiplication, and convolution operations are also modified so as to provide operations for the translated signal components that are substantially equivalent to those operations for untranslated signals. In aspects of the invention, these operations are defined as follows.

A discrete signal x[n] is a Piecewise Non-Zero (PWNZ) signal if it can be described as follows:

$$x [ n ] = \{ \begin{matrix}{x}_{i} [ n ] & {N}_{iL} \leq n \leq {N}_{iH} \\ 0 & E . W\end{matrix} \\ 1 \leq i \leq M > ∞ \\ n ∈ Z \\ {N}_{iL} \leq {N}_{iH} < ∞ \\ {N}_{iL} , {N}_{iH} ∈ Z \qquad ( 1 )$$

A discrete signal x[n] is a Equally Piecewise Non-Zero (EPWNZ) signal if it is PWNZ with the following properties:
N_{iH}−N_{iL}+1=L_{P}
∀iε[1,M] (2)
where L_{P} is the piece length

Using the compressed vector terminology of above, a compressed vector-based (CVB) equivalent of an EPWNZ signal is:

$${x}_{VP} [ n ] = [ \begin{matrix}{x}_{1} [ n ] \\ … \\ … \\ {x}_{M} [ n ]\end{matrix} ] or {x}_{VP} = [ \begin{matrix}{x}_{1} \\ … \\ … \\ {x}_{M}\end{matrix} ] \qquad ( 3 )$$

Where xᵢεR^{1×L}^{_{P}} and x_{VP}εR^{M×L}^{_{P}}

Summation of CVB equivalent signals may be considered as:

Given zᵥₚ[n] as the summation of xᵥₚ[n] and yᵥₚ[n] (i.e. zᵥₚ[n]=xᵥₚ[n]+ᵥₚyᵥₚ[n] where “+ᵥₚ” is a symbol of summation of two CVB equivalent signals), then

$${z}_{VP} [ n ] = {x}_{VP} [ n ] {+}_{VP} {y}_{VP} [ n ] \\ {z}_{VP} [ n ] = [ \begin{matrix}{z}_{1} [ n ] \\ … \\ … \\ {z}_{M} [ n ]\end{matrix} ] = [ \begin{matrix}{x}_{1} [ n ] + {y}_{1} [ n ] \\ … \\ … \\ {x}_{M} [ n ] + {y}_{M} [ n ]\end{matrix} ] \qquad ( 4 )$$

Where xᵢ, yᵢ, and zᵢεR^{1×L}^{_{P}} and x_{VP}, y_{VP}, and z_{VP}εR^{M×L}^{_{P}}. Also “+” is the component wise summation of two 1×L_{P} vectors.

Subtraction of CVB equivalent signals may be considered as:

Given zᵥₚ[n] as the subtraction of xᵥₚ[n] and yᵥₚ[n] (i.e. zᵥₚ[n]=xᵥₚ[n]−ᵥₚ yᵥₚ[n] where −ᵥₚ is a symbol of subtraction of two CVB equivalent signals), then

$${z}_{VP} [ n ] = {x}_{VP} [ n ] {-}_{VP} {y}_{VP} [ n ] \\ {z}_{VP} [ n ] = [ \begin{matrix}{z}_{1} [ n ] \\ … \\ … \\ {z}_{M} [ n ]\end{matrix} ] = [ \begin{matrix}{x}_{1} [ n ] - {y}_{1} [ n ] \\ … \\ … \\ {x}_{M} [ n ] - {y}_{M} [ n ]\end{matrix} ] \qquad ( 5 )$$

Where xᵢ, yᵢ, and zᵢεR^{1×L}^{_{P}} and x_{VP}, y_{VP} and z_{VP}εR^{M×L}^{_{P}}. Also “+” is the component wise subtraction of two 1×L_{P} vectors.

Multiplication of CVB equivalent signals may be considered as:

Given zᵥₚ[n] as the multiplication of xᵥₚ[n] and yᵥₚ[n] (i.e. zᵥₚ[n]=xᵥₚ[n] Xᵥₚ yᵥₚ[n] where “Xᵥₚ” is a symbol of multiplication of two CVB equivalent signals), then

$${z}_{VP} [ n ] = {x}_{VP} [ n ] {\times }_{VP} {y}_{VP} [ n ] \\ {z}_{VP} [ n ] = [ \begin{matrix}{z}_{1} [ n ] \\ … \\ … \\ {z}_{M} [ n ]\end{matrix} ] = [ \begin{matrix}{x}_{1} [ n ] \times {y}_{1} [ n ] \\ … \\ … \\ {x}_{M} [ n ] \times {y}_{M} [ n ]\end{matrix} ] \qquad ( 6 )$$

Where xᵢ, yᵢ, and zᵢεR^{1×L}^{_{P}} and x_{VP}, y_{VP}, and z_{VP}εR^{M×L}^{_{P}}. Also “x” is the component wise multiplication of two 1×L_{P} vectors.

Division of CVB equivalent signals may be considered as:

Given zᵥₚ[n] as the division of xᵥₚ[n] and yᵥₚ[n] (i.e. zᵥₚ[n]=xᵥₚ[n]÷ᵥₚ yᵥₚ[n] where “÷ᵥₚ” is a symbol of division of two CVB equivalent signals), then

$${z}_{VP} [ n ] = {x}_{VP} [ n ] {\div }_{VP} {y}_{VP} [ n ] \\ {z}_{VP} [ n ] = [ \begin{matrix}{z}_{1} [ n ] \\ … \\ … \\ {z}_{M} [ n ]\end{matrix} ] = [ \begin{matrix}{x}_{1} [ n ] \div {y}_{1} [ n ] \\ … \\ … \\ {x}_{M} [ n ] \div {y}_{M} [ n ]\end{matrix} ] \qquad ( 7 )$$

Where xᵢ, yᵢ, and zᵢεR^{1×L}^{_{P}} and x_{VP}, y_{VP}, and z_{VP}εR^{1×L}^{_{P}}. Also “÷” is the component wise division of two 1×Lₚ vectors.

Scalar multiplication of a CVB equivalent signal may be considered as:

Given zᵥₚ[n] as the scalar multiplication of xᵥₚ[n] with the scalar á (i.e. zᵥₚ[n]=á.ᵥₚxᵥₚ[n] where “.ᵥₚ” is a symbol of a scalar multiplication of a CVB equivalent signal with a scalar), then

$${z}_{VP} [ n ] = α {\cdot }_{VP} {x}_{VP} [ n ] \\ {z}_{VP} [ n ] = [ \begin{matrix}{z}_{1} [ n ] \\ … \\ … \\ {z}_{M} [ n ]\end{matrix} ] = [ \begin{matrix}α {x}_{1} [ n ] \\ … \\ … \\ α {x}_{M} [ n ]\end{matrix} ] \qquad ( 8 )$$

Where xᵢ, and zᵢεR^{1×L}^{_{P}} and x_{VP}, and z_{VP}εR×L^{_{P}}. Also “axᵢ” is the componentwise scalar multiplication of a1×L_{P} vector and a scalar.

Convolution of CVB equivalent signals may be considered as:

Given zᵥₚ[n] as the convolution of xᵥₚ[n] and

$${y}_{vp} [ n ] \text{(} i . e . {z}_{VP} [ n ] = {x}_{VP} [ n ] {⊗}_{VP} {y}_{VP} [ n ] where “ {⊗}_{VP} ” then$$

$${z}_{j} = \{ \begin{matrix}{\sum }_{k = 1}^{M - i} {y}_{( M + 2 - l - k )} ⊗ {x}_{( M + 1 - k )} + {\sum }_{k = 1}^{i} {y}_{Fk} ⊗ {x}_{F ( l + 1 - k )} + {\sum }_{k = i + 1}^{M - i} {y}_{Fk} ⊗ {x}_{F ( k - l + 1 )} + {y}_{F ( M )} ⊗ {x}_{( M + 1 - l )} & i ∈ [ 1 , M - 2 ] \\ {\sum }_{k = 1}^{M - i} {y}_{( M + 2 - i - k )} ⊗ {x}_{( M + 1 - k )} + {\sum }_{k = 1}^{i} {y}_{Fk} ⊗ {x}_{F ( i + 1 - k )} + {y}_{F ( M )} ⊗ {x}_{( M + 1 - l )} & i = M - 1 \\ {\sum }_{k = 1}^{2 Mi - l - 1} {y}_{F ( k + i - M )} ⊗ {x}_{( M - k + 1 )} + {y}_{F ( M )} ⊗ {x}_{( i - M + 1 )} & i ∈ [ M , 2 M - 2 ] \\ {y}_{F ( M )} ⊗ {x}_{( i - M + 1 )} & i = 2 M - 1\end{matrix} \qquad ( 9 )$$

In which x_{Fi} and y_{Fi} are flipped version of xᵢ and yᵢ respectively (i.e. x_{Fi}(n)=xᵢ(length(xᵢ)−n)). M is the maximum number of sub-pieces taken into account, and \textcircled{x} is as follows:

$${x}_{i} ⊗ {y}_{j} = {\int }_{- ∞}^{∞} {x}_{i} ( F ) {y}_{j} ( F - f ) ⅆ F \qquad ( 10 )$$

In some aspects of the invention, xᵢ\textcircled{x}yⱼ is substituted with a regular convolution if yⱼ(F−f)=yⱼ(f−F).

FIG. 3 is a block diagram of a simulation system using frequency bands of interest, in some aspects in terms of compressed vectors as discussed above. In the block diagram of FIG. 3, an input signal 301 (or signals) is provided to a converter 303. The converter converts the input signal to a CVB signal. The conversion in some embodiments makes use of appropriate approximation functions such as a sinc function or other functions. The converter provides the CVB signal to a CVB processing block 305, which performs various operations as described on the input signal and signals generated internal to the CVB processing block. The signals generated internal to the CVB processing block may be formed by internal signal generation blocks, by processing the input signal, by various combinations of the two, or signals ultimately generated from a combination of some or all of these signals. The CVB 35 processing block provides resulting signals to a reconversion block 307. The reconversion block converts the signals back to the form of the input signals, either time domain signals or frequency domain signals as the case may be. If appropriate, Fast Fourier Transform (FFT) and inverse FFT (iFFT) processing may be used. The reconversion block provides an output signal 309 (or signals).

In various aspects of the invention the CVB signals are in terms of dB, while in other aspects of the invention other scales are used.

FIG. 4 is a flow diagram of a process of simulating a component or system using frequency bands of interest. In Block 401 an input signal (or signals) is converted to a CVB format. In block 403 the system is simulated using CVB operations, for example as described above, and CVB format results are produced. In block 405 the CVB format results are reconverted to the form of the input signal and provided as an output.

FIG. 5 is a block diagram of a CVB processing block. The CVB processing block receives an input signal 501 in CVB format. The input signal is provided to a first simulation block 503. The first simulation block performs operations as described above and below. The CVB processing block also includes a first signal generator block 505 and a second signal generator block 507. In some embodiments, the signal generator blocks are white Gaussian noise generators, adjustable single tone generators, adjustable two tone generators, adjustable mult-tone generators, GSM900 standard power spectral density (PSD) mask generators, GSM900 adjustable PSD mask generators, GSM standard Interferer generators, GSM adjustable Interferer generators, or adjustable white Gaussian noise generators or oscillators. The signal generation blocks may be developed using the operations described above and below.

In the CVB processing block of FIG. 5 the first signal generator block provides a signal to a second simulation block 509. The second signal generator provides a signal to the first simulation block and the second simulation block. The first simulation block performs operations as described above and below using its input signals. Similarly, the second simulation block performs operations as described above and below using its input signals. The first simulation block and the second simulation block each provide a signal, formed by the performing of operations, to a third simulation block 511. The third simulation block performs operations as described above and below using its input signals. The third simulation block provides an output signal, formed by the performing of operations.

In various embodiments the simulation blocks may be considered as combinations of the operations described above. For example, the simulation blocks may be Linear Time Invariant without memory (LTI) blocks, Linear Time Invariant with memory (LTIM) blocks, Non-Linear Time Invariant without memory (NLTI) blocks, and Non-Linear Time Invariant with memory (NLTIM) blocks. These blocks may in turn be used to form low noise amplifier blocks, mixer blocks, and other blocks.

As a notation convenience, an input to a block may be considered to be x(t) and an output of a block may be considered y(t). Also as a notation convenience X(f) and Y(f) may be considered Fourier tranforms of x(t) and y(t), respectively.

For an LTI operation y(t)=á₁x(t) and Y(f)=á₁X(f), where á₁ is a constant scalar. The CVB equivalent representation of the LTI operation, the LTI block, in the frequency domain is Yᵥₚ(f)=á₁.ᵥₚXᵥₚ(f).

For an LTIM operation

$$y ( t ) = {\int }_{- ∞}^{∞} h ( τ ) x ( t - τ ) ⅆ τ and Y ( f ) = H ( f ) X ( f ) ,$$

where H(f) is the

Fourier transform of the impulse response h(τ).

The CVB equivalent representation of the LTIM operation, the LTIM block, in the frequency domain is

$${Y}_{VP} ( f ) = {H}_{VP} ( f ) {\times }_{VP} {X}_{VP} ( f ) ,$$

where Hᵥₚ(f) is the CVB equivalent of H(f).

For an NLTI operation,
y(t)=a₀+a₁x(t)+a₂x²(t)+a₃x³(t)+ . . .
Y(f)=a₀δ(f)+a₁X(f)+a₂X(f)*X(f)+a₃X(f)*X(f)*X(f)+ . . .

Where a₁, a₂, . . . are coefficients representing non-linearity of a device and * indicates convolution of two signals. The coefficients may be extracted, for example, by performing curve fitting on a curve relating inputs and outputs of the device. The CVB equivalent representation of the NLTI operation, the NLTI block, in the frequency domain is

$${Y}_{VP} ( f ) = {α}_{0} + {α}_{1} {\cdot }_{VP} {X}_{VP} ( f ) + {α}_{2} {\cdot }_{PV} {X}_{VP} ( f ) {⊗}_{VP} {X}_{VP} ( f ) + {α}_{3} {\cdot }_{VP} {X}_{VP} ( f ) {⊗}_{VP} {X}_{VP} ( f ) {⊗}_{VP} {X}_{VP} ( f ) + …$$

In some embodiments NLTIM blocks are modeled as combinations of NLTI sub-blocks and LTIM sub-blocks. In other embodiments a Volterra series method is used. In a Volterra series an n^{th} order non-linear operator is described as

$$y ( t ) = {\int }_{- ∞}^{∞} {h}_{1} ( {τ}_{1} ) x ( t - {τ}_{1} ) ⅆ {τ}_{1} + … + {\int }_{- ∞}^{∞} … {\int }_{- ∞}^{∞} {h}_{n} ( {τ}_{1} , … {τ}_{n} ) x ( t - {τ}_{1} ) … x ( t - {τ}_{n} ) ⅆ {τ}_{1} … ⅆ {τ}_{n}$$

in which x(t) is the input, y(t) is the output, and hₙ(τ₁, . . . τₙ)=0 for any τ_{J}<0 j=1, . . . , n).

Further information may be found in Schetzen, M., “The Voleterra and Wiener Theories of Nonlinear Systems” (1980), the disclosure of which is incorporated by reference.

Simulation may be computationally expensive when convolution operations are performed in the frequency domain. Accordingly, in some embodiments of the invention CVB equivalent signals in the time domain are used, allowing for, for example, multiplication in the time domain instead of convolution in the frequency domain. A real time domain signal s(t) has a Fourier transform S(f). S_{vb}(f) is a CVB equivalent representation in the frequency domain. The CVB equivalent representation in the time domain is s_{vb}(t), with

$${s}_{VB} ( t ) = [ \begin{matrix}{s}_{VB 0} ( t ) \\ {s}_{VB 1} ( t ) \\ … \\ {s}_{VBM} ( t )\end{matrix} ]$$

$$and$$

$${s}_{VBk} ( t ) = [ s ( t ) . exp ( - j 2 π {kf}_{c} t ) ] * [ ( \frac{1}{π t} ) . sin ( π Bt ) ]$$

which utilizes an approximation function, and where fc is the the carrier frequency and B is the bandwidth of interest. For the frequency domain

$${S}_{VB} ( f ) = [ \begin{matrix}{S}_{VB 0} ( t ) \\ {S}_{VB 1} ( t ) \\ … \\ {S}_{VBM} ( t )\end{matrix} ]$$

$$with$$

$${S}_{VBk} ( f ) = F \{ {s}_{VBk} ( t ) \}$$

CVB equivalent systems are formed using a combination of frequency shift blocks and samplings. For example f(x)=x²,

$${f}_{VB} ( {x}_{VB} ) = [ \begin{matrix}{f}_{VB 0} ( {x}_{VB} ) \\ {f}_{VB 1} ( {x}_{VB} ) \\ … \\ {f}_{VBM} ( {x}_{VB} )\end{matrix} ]$$

may be implemented as shown in FIG. 13, with a sampling frequency greater than the signal bandwidth.

FIG. 6 is a block diagram of a simplified RF receiver front-end. The front-end includes an LNA 601 receiving an input signal. The LNA amplifies the input signal to provide a first input to a mixer 603. The mixer receives as a second input the output of a local oscillator (LO) 605. The mixer mixes the two signals to form an output signal.

As an example, the input signal is a GSM900 standard Interference signal. FIG. 7 is a graph of the input signal as provided by a CVB signal generation block. FIG. 8 is a graph of an output of the LNA when the LNA is provided the input signal of FIG. 7 and the LNA is modeled as an LTI block. Similarly, FIG. 9 is a graph of an output of the mixer of FIG. 6 when the mixer is modeled as a linear mixer.

The system of FIG. 6 may also be modeled as a non-linear system. For example, the LNA may be modeled as NLTI block. In one embodiment, the LNA is modeled as an NLTI with
y(t)=a₀+a₁x(t)+a₂x²(t)+a₃x³(t)

With the non-linear coefficients derived from curve fitting, with curves generated for example using tools from Cadence corporation. In the example described the coefficients are
a₀=0 a₁=1 a₂=0.27 a₃=−4.5.

Similarly, the mixer may be modeled as a non-linear block. In the example described, the mixer is modeled in accordance with the block diagram of FIG. 10. In FIG. 10, the mixer is an NLTI block 1001. The NLTI block receives an input from an LO 1003. In addition, with RF input to the mixer, LO to RF leakage is modeled using a gain block 1005, with LO to RF isolation being 30 dB. RF to IF leakage and RF to LO leakage are assumed negligible. The mixer is modeled by
y(t)=a₀+a₁x(t)+a₃x³(t)

The coefficients are derived using curve fitting, with for example curves generated using tools from Cadence Corporation. In the described example, the coefficients are
a₀=0 a₁=1 a₂=0.32 a₃=−3.21.

Simulation results are shown in the graphs of FIGS. 11 and 12, with the graph of FIG. 11 showing the LNA output and the graph of FIG. 12 showing the mixer output. The simulation time, using an Intel Corporation Pentium 4 equiped personal computer with a frequency resolution of 5 KHz and a 6 GHz signal bandwith, was less than one minute.

Accordingly, the invention provides a modeling system and method using compressed vectors. Although the invention has been described in certain embodiments, it should be recognized that the invention encompasses the claims supported by this disclosure and the their equivalents.

What is claimed is:

1. A method of simulating radio frequency signal processing circuitry, comprising:
forming a compressed vector based equivalent of a signal;
performing processing on the compressed vector based equivalent to simulate radio frequency circuitry operation, the processing forming a processed compressed vector based equivalent of the signal; and
forming an output signal using the processed compressed vector based equivalent of the signal.

2. The method of claim 1 wherein information in the compressed vector based equivalent of the signal is limited to information of the signal in frequency bands of interest.

3. The method of claim 1 wherein the processing simulates non-linear operations.

4. The method of claim 1 wherein the processing is compressed vector based processing.

5. The method of claim 1 wherein the processing includes linear time invariant processing and non-linear time invariant processing.

6. The method of claim 1 wherein the processing is frequency domain processing.

7. The method of claim 1 wherein the processing is time domain processing.

8. The method of claim 1 wherein the processing simulates RF receiver front-end processing.

9. The method of claim 2 wherein the signal is centered about a carrier frequency, and the frequency bands of interest include the carrier frequency and harmonics of the carrier frequency.

10. The method of claim 9 wherein the signal is bandwidth limited to a bandwidth B, and the frequency bands of interest are limited to the bandwidth B.

11. A method of modelling circuitry, comprising:
converting first signals to compressed equivalent signals;
processing the compressed equivalent signals to form further compressed equivalent signals; and
converting the further compressed equivalent signals to second signals.

12. The method of modelling circuitry of claim 11 wherein the first signals are signals about a carrier frequency and harmonics and sub-harmonics of the carrier frequency and the compressed equivalent signals are formed by restricting information in the compressed equivalent signals to signal components about the carrier frequency and harmonics and sub-harmonics of the carrier frequency.

13. The method of modelling circuitry of claim 12 wherein the first signals are bandwidth limited and the compressed equivalent signals are bandwidth limited.

14. A system for performing RF signal processing modelling, the system comprising:
signal generator blocks forming compressed vector based equivalent signal representations;
RF signal processing blocks processing compressed vector based equivalent signal representations; and
conversion blocks converting compressed vector based equivalent signals to RF signal representations.

15. The system of claim 14 wherein the RF signal processing blocks are formed using sub-blocks comprising linear time invariant blocks and non-linear time invariant blocks.
